(19) United States
(12) Patent Application Publication
(10) Pub. No.: US 2025/0171642 A1
(43) Pub. Date: May 29, 2025

(54) PREAPPLIED WATERPROOFING BONDING COATING AND SYSTEMS AND METHODS INVOLVING THE SAME AND METHODS INVOLVING THE SAME

(71) Applicant: GCP Applied Technologies Inc., Malvern, PA (US)

(72) Inventors: Qian Wang, Beijing (CN); Huhe Chen, Shanghai (CN); Xia Cao, Acton, MA (US)

(21) Appl. No.: 18/843,687

(22) PCT Filed: Mar. 4, 2022
(86) PCT No.: PCT/CN2022/079274

§ 371 Date: Sep. 3, 2024

(51) Int. Cl. C09D 5/02; C09D 5/16; C09D 7/61; C09D 7/65; C09J 7/38; E04B 1/64; E04B 1/66

(52) U.S. Cl. CPC C09D 5/022; C09D 5/16; C09D 7/61; C09D 7/65; C09J 7/38; E04B 1/644; E04B 1/665

(57) ABSTRACT

Waterproofing bonding coating compositions comprise synthetic film-forming polymer having very small average particle size within emulsion systems that enable the coating to be used on various substrates, including formwork, conventional as well as pre-applied waterproofing membranes, and even on other coatings, to provide an excellent waterproofing bond with post-cast concrete. Waterproofing bonding coating compositions can be applied in liquid form upon various substrates and building surfaces. They can be used in the manner of a bonding coating layer, or additional bonding coating layer, when applied upon membranes installed at the building site, or, alternatively, when incorporated onto the membrane as an outermost layer at the membrane manufacturing plant. The waterproofing bonding coating can be used to enhance water- and weather-resistance in both conventional and pre-applied waterproofing membranes.

### FIELD OF THE INVENTION

The invention relates to the field of waterproofing compositions, and more particularly to a coating or layering composition having film-forming properties such that it can be used as a pre-applied waterproofing bonding coating composition, which, in exemplary embodiments, can be applied as liquid onto a substrate or building surface, or can be used as a pre-applied waterproofing bonding coating layer applied upon a pre-applied or post-applied waterproofing membrane or incorporated during manufacture of a pre-applied waterproofing membrane laminate, thereby conferring in these different applications properties including UV and water resistance, and particularly a waterproofing bonding ability with respect to concrete that is subsequently applied (post-cast) against the coating composition.

### BACKGROUND OF THE INVENTION

“Pre-applied” membranes are known in the waterproofing arts. Such waterproofing membranes are installed first upon a substrate or building surface, and then used for forming a waterproofing bond with “post-cast” concrete, or, in other words, with fresh concrete that is subsequently poured, sprayed (e.g., shotcrete), or otherwise applied against and allowed to harden (i.e., cure) and bond with the installed membrane.

For example, in U.S. Pat. No. 4,994,328, Cogliano disclosed a waterproofing membrane capable of adhering to freshly poured concrete, an early example of “blind-side” or “pre-applied” waterproofing. The membrane comprised a bituminous adhesive layer coated with a water-insoluble polymer, e.g., polyvinyl alcohol, silica, and glycerin mixture. The coating purportedly protected the adhesive layer while permitting a post-cast concrete to bond to the adhesive.

In U.S. Pat. No. 5,316,848, Bartlett discloses a pre-applied waterproofing membrane having a carrier layer, pressure-sensitive adhesive layer (PSA), and styrene butyl acrylate protective coating, which can be applied as a latex onto the PSA.

In U.S. Pat. No. 5,496,615, Bartlett discloses a similar pre-applied membrane wherein a protective coating of sand, calcium carbonate, cement, and titanium dioxide particles were dusted thereon. The size of the fine particles were in the range of 0.1 to 1000 μm, preferably 0.2 to 100 um, were dusted onto the protective coating.

In WO2017058154, Chen et al. disclose a pre-applied membrane having carrier sheet, PSA layer, and an inorganic silica-containing particle layer partially embedded in the PSA layer, a coating layer attached to un-embedded portions of the inorganic particles, intended to prevent total embedment into the PSA layer when the membrane is rolled.

In WO2020/118515A1, Chen et al. disclosed a pre-applied membrane having carrier sheet, PSA layer, aluminum oxide trihydrate particles partially embedded into the PSA layer, and an outer polymeric protective coating layer attached to the particulate layer. The top coating of Chen et al. provides immunity to dust, dirt, water immersion, high temperature and other detrimental conditions, while also providing excellent bonding strength with post-cast concrete (See WO2020/118515A1 at paragraphs [0010] through [0013]).

The foregoing art references are or were owned by the common assignee hereof (and/or its predecessor company). These summaries are provided for illustrative purposes and not to be construed as any admission of material relevance to the determination of patentability of the present invention.

### SUMMARY OF THE INVENTION

In the present invention, the inventors seek to achieve excellent performance of a waterproofing bonding coating composition, which can be used as an outermost coating layer on pre-applied waterproofing membranes, and/or which can also be used as a separately applied coating on the job site (e.g., on installed pre-applied membranes for example) to achieve excellent waterproofing bonding properties when used to receive concrete that is cast against the coating composition in layer form.

Exemplary waterproofing bonding coatings of the invention can also be used to establish a monolithic waterproofing bonding barrier, even when using various components such as membranes and coatings, and even when these are installed on various surfaces (e.g., whether formwork, soil retention systems, slabs, membranes on building surface).

The waterproofing bonding coating composition of the present invention can be used as a stand-alone (reverse-tanking) waterproofing system by itself; or, in other words, the coating composition can be applied directly onto a building or civil engineering substrate, or form work surface, to establish a pre-applied waterproofing membrane, to bond with concrete that is subsequently applied (post-cast) against the coating composition. The coating composition of the invention is believed to be effective for pre-applied applications even when applied by itself onto various substrates: such as a form work, a building surface (e.g., foundation, wall), or civil engineering surface (e.g., tunnel wall, wall cladding, etc.), or even onto coatings or laminate membranes which are non-preapplied type.

The waterproofing bonding coating composition of the present invention is believed to provide greater versatility in that it can be used by itself, such as by one or more separate coating applications, or such as directly to a substrate or construction surface, and convers excellent UV and water immersion resistance, while at the time achieving a strong bond with post-cast concrete (e.g., subsequently spray applied or poured) directly onto the coating composition. The waterproofing bonding coating composition may, for example, be applied onto the PSA layer and/or waterproofing bonding coating layer of rollable/unrollable waterproofing (laminate) membranes at the plant where such membranes are manufactured, or they may be applied at the construction site.

In further exemplary embodiments, the waterproofing bonding coating composition may include additional or white pigments, to provide waterproofing bonding coating layer and/or further protection to the PSA layer and/or waterproofing bonding coating layer of pre-applied membrane installed at the construction site. In still further exemplary embodiments, the waterproofing bonding coating composition of the invention may be applied, either at the factory or construction site, onto conventional waterproofing membranes that are not intended or designed for pre-applied applications, to convert them into pre-applied membranes that form waterproofing bond with post-cast concrete.

The waterproofing bonding coating compositions of the present invention may also be spray applied onto cladding and/or waterproofing drainage materials, and/or geotextile, vapor barrier, foam materials such as used in foundation wall or tunnel waterproofing applications, for bonding with shotcrete or concrete that is sprayed or extruded or otherwise cast against inner tunnel walls or membrane assemblies to form a waterproofing bond with such shotcrete or extruded or cast concrete.

The terms “bond,” “water-proofing bond,” “waterproofing bonding,” “bonding ability,” and the like, when used in reference to the contact between the coating composition of the present invention and post-cast concrete, will be understood to be a fully adhered bond or waterproofing bond that can prevent lateral water migration. This means that after the composition is applied onto a substrate, form work, membrane, or other surface, water from a leak through a membrane defect or opening at a seam, puncture, or other opening in the membrane is not allowed to travel in a space between the coating composition layer and post-cast concrete layer to a crack or opening (e.g., a pipe conduit) through which the water can enter into the concrete structure.

In alternative exemplary embodiments, the waterproofing-bonding coating composition can be applied to or used within pre-applied waterproofing membrane laminates to provide increased protection and/or to improve bonding with fresh concrete post-cast against the membrane. For example, the coating compositions of the present invention, preferably containing white pigments, fillers, or mixture thereof, can be coated onto membranes at the factory or at the installation site, to provide enhanced UV and water immersion protection, while also enabling an excellent bonding ability with fresh concrete that is post-cast against the coating.

A protective coating composition having relatively large film-forming polymer particle size is illustrated in FIG. 1; while FIG. 2 illustrates a waterproofing coating composition comprising comparatively smaller synthetic polymer particles. The present inventors believe that the use of small film-forming polymer particles has greater tendency to decrease the chances that voids (air spaces) will form or arise in the resultant formed film, and that in some exemplary embodiments of the invention smaller particles can be used advantageously in combination with larger particles to establish higher packing density that can provide benefits in terms of establishing waterproofing bonding between the coating layer and post-cast concrete, and hence benefiting water resistance.

When used in the context of latex or latex emulsions, the term “polymer particle” will be understood to refer to a stabilized polymer emulsion wherein the polymer particles are dispersed within an aqueous phase of the emulsion. An exemplary polymer can be chosen from polyvinyl acetate, acrylate (e.g., poly methacrylate, polyacrylate), an acrylate with reactive functionality (e.g., hydroxy group(s), acid group(s), silane group(s)), acrylate copolymers (e.g., acrylate/vinyl acetate copolymer, acrylate/styrene copolymer, acrylate/silicone copolymer, acrylate/polyurethane copolymer, acrylate/epoxy copolymer), and mixtures thereof.

The terms “polymer particle size” and the like, when used in reference to a latex or latex emulsion, can be measured by common light scattering techniques for determining the average particle size and distribution. The average particle size of polymer particles within latex emulsion may be expressed as volume or weight average diameter Dv50, which has been defined as the size in microns that splits the particle size distribution, wherein 50% in weight or volume is above and 50% in weight or volume is below this diameter.

Thus, in an example embodiment, the present invention provides a method for establishing a waterproofing bond with post-cast concrete, comprising:
(A) providing a substrate chosen from formwork (e.g., timber lagging, wooden form or mold; or fabric, geotextile, drainage board, or mat placed over a wooden form or mold, timber lagging, or other substrate), a waterproofing membrane established by application of a previous coating composition or a rollable/unrollable sheet-form membrane having a carrier layer, a building surface, a civil engineering surface, or any combination of the foregoing substrates; and
(B) applying onto the substrate, to establish a waterproofing bond for concrete that is subsequently cast against the substrate, a waterproofing bonding coating composition which is an aqueous synthetic polymer emulsion system comprising: (i) at least one film-forming synthetic polymer present in the amount of 5% to 100%, preferably in the amount of 50% to 100%, more preferably in the amount of 80% to 100%, based total weight of the aqueous synthetic polymer emulsion system, wherein the average particle size of the at least one film-forming synthetic polymer is in the range of 5 to 150 nanometers; and, optionally, (ii) a surfactant in the amount of zero to no greater than 1%, and preferably zero to no greater than 0.5% and more and preferably zero to no greater than 0.1%, based on total weight of the aqueous synthetic polymer emulsion system.

In a further exemplary method, concrete is then cast against the waterproofing bonding coating composition side and allowed to cure against the coating composition.

In another example embodiment, the invention provides a waterproofing bonding coating composition comprising: an aqueous synthetic polymer emulsion system comprising: at least one film-forming synthetic polymer present in the amount of 5% to 100%, preferably in the amount of 50% to 100%, more preferably in the amount of 80% to 100%, based total weight of the aqueous synthetic polymer emulsion system, wherein the average particle size of the at least one film-forming synthetic polymer is in the range of 5 to 150 nanometers; and, optionally, a surfactant in the amount of zero to no greater than 1%, and preferably zero to no greater than 0.5% and more and preferably zero to no greater than 0.1%, based on total weight of the aqueous synthetic polymer emulsion system.

In another example embodiment, the invention provides a waterproofing membrane having at least one carrier sheet, preferably at least one pressure-sensitive adhesive layer, optionally a protective coating layer (e.g., layer of particles, layer of elastomeric coating, or combination thereof), and the above-described waterproofing bonding coating composition of the invention made of the aqueous synthetic polymer emulsion system. Exemplary membranes can be provided as a rollable/unrollable sheet-form laminate that can be made using components as previously known and used in the pre-applied membrane arts, or it can be a flexible carrier sheet having contiguously attached therewith a pre-formed pressure-sensitive (PSA) layer (e.g., rollable at the factory for shipment in boxes or bags to the construction site where it is unrolled for installation). This membrane with PSA layer, and optional protective coating (e.g., elastomeric coating, particles, or mixture thereof) can be coated with the waterproofing bonding coating composition of the invention either in the factory where the waterproofing membrane is manufactured, or at the construction site after the membrane is attached to a formwork, a building surface (e.g., foundation structure), or a civil engineering surface (e.g., tunnel surface, membrane, and/or drainage device). Waterproofing membranes, whether pre-applied or conventional nature, can be supplied with or without removable release sheet (as well as with or without removable edge release strips along one or both longitudinal edges of the membrane to cover edge adhesive portions intended for adhering a membrane to an adjacent membrane or to a substrate such as formwork or a wall), depending on design choice.

The invention accordingly comprises features of construction, combination of elements, and arrangement of parts that will be further exemplified in the following detailed description.

### BRIEF DESCRIPTION OF DRAWINGS

An appreciation of the benefits and features of exemplary embodiments disclosed herein may be more readily comprehended when the following written description of the example embodiments is considered in conjunction with the drawings, wherein

FIG. 1 is a representative illustration of large particle size synthetic polymer emulsion which is illustrated as having relatively large void volume between the synthetic polymer particles when the polymer emulsion is allowed to dry and to form a film layer.

FIG. 2 is a representative illustration, arranged to the right side of the illustration of FIG. 1 for comparative same-sizing illustration purposes, of an exemplary smaller synthetic polymer particle size emulsion according to the present invention, wherein comparatively smaller voids are shown to arise between the smaller synthetic polymer particles when the emulsion is allowed to dry and form a film layer, even when used with larger particle size of larger synthetic polymer particles, as the smaller synthetic particle sizes help to fill up void volume (air space) between the synthetic polymer particles when the film is formed.

FIG. 3 is a representative illustration, arranged immediately beneath the illustration of FIG. 1 for comparative same-sizing illustration purposes, of a synthetic polymer particle size emulsion having substantial percentage of small particle size (e.g., wherein the polymer is 5%-100%, and more preferable 80%-100%, by volume of the emulsion and have average particle size in the range of 5 to 150 nanometers) which is believed to result in greater UV and water resistance when emulsion is allowed to dry and form a film with better packing density of small and large particles, as compared to films made from latexes having larger particle sizes. (For simplicity of comparative illustration as between FIGS. 1-3, FIG. 3 shows mostly small sized particles to suggest the benefits of tight packing).

FIG. 4 is a cross-sectional diagram of exemplary silane functional groups on small synthetic polymer particles within exemplary waterproofing bonding coating compositions of the present invention.

FIG. 5 is a partial, cross-sectional representational diagram, not drawn to scale, of an exemplary waterproofing membrane (10) of the present invention having at least one carrier sheet layer (designated at 12), preferably a pressure-sensitive adhesive layer (designated at 14), optionally a protective coating layer (designated at 16), e.g., a particle coating layer, elastomeric coating layer, or mixture of these (designated altogether at 16), and an exemplary waterproofing bonding coating (designated at 20) of the present invention used as an outermost (facing top of the page in the drawing) layer against which post-cast concrete can be applied.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±15% of the numerical. In exemplary embodiments, the term “about” can include traditional rounding according to significant figures of the numerical value. In addition, the phrase “about ‘x’ to ‘y’” includes “about ‘x’ to about ‘y’”.

The term “pre-applied” is typically used herein to refer to a coating or membrane placed that is first placed against a substrate, such as a formwork or wall, against which a plastic concrete is subsequently cast (it can be said to be “post-cast”) against the coating or membrane, against which it is intended to bond. Such technique for “blind-side” or “reverse-tanking” waterproofing.

It is intended that the concrete which post-cast against the pre-applied waterproofing bonding coating compositions of the invention will form a waterproofing bond and that travel of any moisture which penetrates between the contacted surface of the concrete and coating composition will be minimized and prevented.

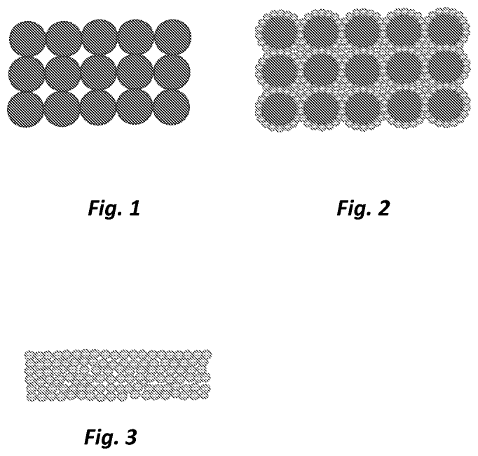

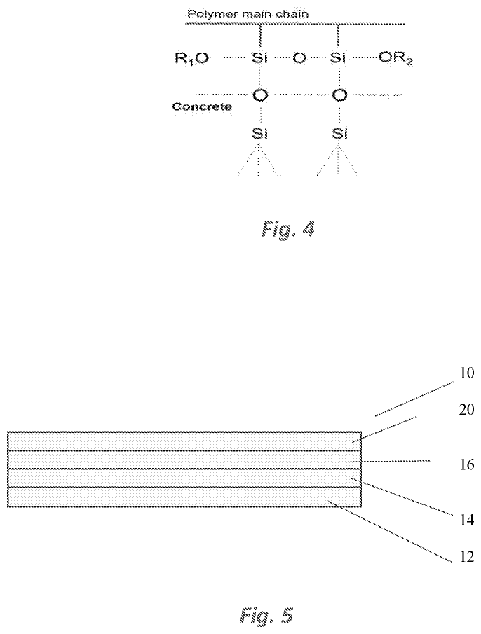

Exemplary waterproofing bonding coating compositions of the invention are established using water-based synthetic polymer emulsion systems in which one or more film-forming synthetic polymers are used having particle sizes and size ranges that are carefully chosen to establish a tight barrier to moisture when the polymer cures/hardens to form a film. As illustrated by the presence of smaller particle sizes (compare the smaller particles as illustrated in FIG. 3 against the larger particles as illustrated in FIG. 1) the present inventors illustrate the fact that void space (air spaces or potential leakage pathways through the polymer film) can be minimized or presented as compared to using only larger polymer particle sizes as illustrated in FIG. 1. The use of smaller polymer particles helps to fill interstices between larger particle particles as illustrated in FIG. 2.

More preferred by the present inventors is the use of film-forming synthetic polymers having average particle sizes that are predominantly in the smallest size ranges. For example, the film-forming synthetic polymer should have an average size in the range of 5 to 150 nanometers, and this size particle polymer should constitute 5% to 100%, preferably 50% to 100%, and more preferably 80% to 100%, by total weight of the aqueous synthetic polymer emulsion system.

It is understood that average particle size and particle size distribution of a polymer emulsion system can be determined through conventional techniques such as light scattering.

An exemplary synthetic polymer contemplated for use in the invention can be chosen from acrylate, acrylate with reactive functionality, polyvinyl acetate, acrylate/vinyl acetate copolymer, acrylate/styrene copolymer, acrylate/silicone copolymer, acrylate/polyurethane copolymer, acrylate/epoxy copolymer, and mixtures thereof. Preferred are mixtures of acrylate and acrylate/silicone.

Also preferred are mixtures of any of the foregoing homopolymers or copolymers, preferably with one or both having UV resistance functionality.

Exemplary waterproofing bonding coating compositions of the invention may also include one or more fillers chosen from calcium carbonate, magnesium carbonate, alumina trihydrate, alumina oxide, dolomite, wollastonite, barium sulfate, crystal or amorphous silica, clay, talc, bentonites, diatomaceous earth, barytes, magnesium silicates, or mixtures thereof.

Exemplary waterproofing bonding coating compositions of the invention include, optionally although preferably, one or more white pigment (which may include a filler identified in the above list). Preferred white (or reflective) pigments contemplated for use in the present invention are chosen from titanium dioxide, antimony oxide, zinc sulfide, zinc oxide, white cement, organic hollow sphere pigment, white cement, or a mixture thereof. Thus, in further exemplary embodiments, one or more white pigments can be incorporated into the waterproofing bonding coating composition.

In other exemplary embodiments, the waterproofing bonding coating composition having the aqueous synthetic polymer emulsion includes one or more white pigments, fillers, or both in the range of 10%-80%, and, more preferably, in the range of 30%-40%, based on total weight of waterproofing bonding coating.

Preferred particle size for white pigments and fillers is in the range of 20 nm-50 um, more preferably in the range of 40 nm-15 μm, and preferably it is used in waterproofing bonding coating compositions of the invention in an amount of 10%-80% filler by dry weight (e.g., based on percentage of the dried coating film).

In other exemplary embodiments, a thickening agent may used to stabilize the use of white pigment, filler, or mixture thereof. An exemplary thickening agent is chosen from hydroxy ethyl cellulose (HEC), hydroxymethyl hydroxyethyl cellulose (HMHEC), as well as other aqueous system thickeners, and mixtures thereof.

The present inventors note that any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

Exemplary embodiments of the invention are illustrated hereinbelow, along with various example aspects of the embodiments. Exemplary methods for establishing a waterproofing bond with post-cast concrete will be described, along with exemplary waterproofing bonding coating compositions, as well as exemplary package systems wherein liquid-form and/or sheet-form membranes may be supplied as part of a package or system along with exemplary waterproofing bonding compositions of the present invention. Exemplary details or aspects of the various method of establishing a waterproofing bond with post-cast concrete, are understood to apply to exemplary waterproofing bonding compositions and packages of the invention; and, vice-versa, or in other words, exemplary aspects or details specified for the composition or packages will be understood to apply to various embodiments of the methods of the invention.

In a first example embodiment, the invention provides a method for establishing a waterproofing bond with post-cast concrete, which comprises:
(A) providing a substrate chosen from formwork, a waterproofing membrane established by application of a previous coating composition (e.g., SILCOR® polyurethane liquid, DECSEAL® acrylic liquid, INTEGRITANK® and ELIMINATOR® brand coatings) or a rollable/unrollable sheet-form membrane having a carrier layer (e.g., such as PREPRUFE® brand, BITUTHENE® brand, or PV® 100 brand rollable pre-applied membranes which are commercially available from GCP Applied Technologies Inc., having offices in Alpharetta, Georgia, and Wilmington, Massachusetts, USA), a building surface (e.g., foundation, floor, wall, corners, penetrations), a civil engineering surface (e.g., soil retention, tunnel wall or cladding), or any combination of the foregoing substrates; and
(B) applying onto the substrate, to establish a waterproofing bond for concrete that is subsequently cast against the substrate, a waterproofing bonding coating composition which is an aqueous synthetic polymer emulsion system comprising: (i) at least one film-forming synthetic polymer present in the amount of 5% to 100%, preferably in the amount of 50% to 100%, more preferably in the amount of 80% to 100%, and most preferably in the range of 90% to 100%, based total weight of the aqueous synthetic polymer emulsion system, wherein the average particle size of the at least one film-forming synthetic polymer is in the range of 5 to 150 nanometers; and, optionally, (ii) a surfactant in the amount of zero to no greater than 1%, and preferably zero to no greater than 0.5% and more and preferably zero to no greater than 0.1%, based on total weight of the aqueous synthetic polymer emulsion system.

Exemplary aspects within the first exemplary embodiment above include various applications or application methods: for example, such as (i) use of the waterproofing bonding coating composition to form a single waterproofing bonding coating (e.g., a pre-applied application or otherwise called a reverse-tanking application) all by itself on a form works or on a building surface or civil engineering surface; (ii) additional protection and bonding ability with post-cast concrete when applied onto pre-applied (reverse-tanking) type membranes (e.g., laminate membranes which are rollable/unrollable due to use of a flexible carrier sheet) which are already installed upon a substrate at the construction site, or whereby the coating composition is applied onto a sheet-like laminate waterproofing membrane at the factory where such membranes are made; (iii) additional protection when applied onto non-reverse-tanking membranes to convert them to pre-applied (reverse-tanking) waterproofing applications; (iv) additional protection when applied onto liquid-applied coating membranes which are not pre-applied (reverse tanking) type membrane-forming liquid-applied coating compositions to convert them to reverse-tanking capability; (v) additional protection when applied onto liquid-applied coating membranes which are pre-applied (reverse tanking) type membrane-forming liquid-applied coating compositions to additional protection and bonding ability with post-cast concrete; and (v) the ability to combine, into a monolithic protection barrier, the various different types of waterproofing compositions and systems as described in sections (i) through (iv) above.

In an example aspect of the first exemplary embodiment, wherein, in the step of providing a substrate, waterproofing laminate membranes are provided as the substrate. Such membranes preferably have flexible carrier layers for carrying pressure-sensitive adhesive (PSA) layer, and optionally outer protective coating layer or layers having inorganic or organic particles embedded upon the outer surface or within the PSA and/or protective coating.

In another example aspect of the first exemplary embodiment, the aqueous synthetic polymer emulsion of the waterproofing bonding coating composition preferably is substantially devoid of surfactant, by which the present inventors prefer that the amount if any of surfactant is zero to no greater than 0.5%, based on total weight of the aqueous synthetic polymer emulsion system, most preferably the aqueous synthetic polymer emulsion contains zero to no greater than 0.1%.

In a second example embodiment, which may be based on the first example embodiment, the invention provides a method wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 150 nanometers, is present in the amount of 5-100% and more preferably 50% to 100%. In a first aspect of this second example embodiment, the at least one film-forming synthetic polymer having an average particle size in the range of 5 to 150 nanometers is present in an amount of 5%-100%.

In a third example embodiment, which may be based on any of the first through second example embodiments, the invention provides a method, wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 150 nanometers, is present in the amount of 80% to 100%.

In a fourth example embodiment, which may be based on any of the first through third example embodiments above, the invention provides a method, wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 150 nanometers, more preferably in the range of 5 to 100 nanometers, is present in the amount of 80% to 100%.

In a fifth example embodiment, which may be based on any of the first through fourth example embodiments above, the invention provides a method, wherein, in applying onto the substrate in step (B), the waterproofing bonding coating composition is applied at a coverage rate of 20-2500 grams per square meter (gsm), more preferably in the range of 30-200 gsm, and most preferably in the range of 30-100 gsm, based on total dry weight of the aqueous synthetic polymer emulsion system.

In a sixth example embodiment, which may be based on any of the first through fifth example embodiments above, the invention provides a method, wherein, in applying onto the substrate in step (B), the waterproofing bonding coating composition has at least one polymer composition in emulsion with glass transition temperature no less than (−) 20° C. and no greater than 100° C., more preferably no greater than 85° C., and most preferably no greater than 65° C. It is believed that this example glass transition temperature range will enhance trafficability of the coating composition.

In a seventh example embodiment, which may be based on any of the first through sixth example embodiments above, the invention provides a method, wherein, in applying onto the substrate in step (B), the waterproofing bonding coating composition has at least one polymer composition in emulsion with glass transition temperature below 0° C. It is believed that such glass transition temperature property will enhance good film formation and low temperature flexibility during installation.

In an eighth example embodiment, which may be based on any of the first through seventh example embodiments above, the invention provides a method, wherein, in applying onto the substrate in step (B), the waterproofing bonding coating composition further comprises a polymer emulsion chosen from fluoroacrylate or fluorinated polymers, copolymer with carboxyl and siloxane functionality that can react or form strong interactions with cement, or a mixture thereof.

In a ninth example embodiment, which may be based on any of the first through eighth example embodiments above, the invention provides a method, wherein, in applying onto the substrate in step (B), the waterproofing bonding coating composition comprises one or more white pigments. Exemplary white pigments contemplated for use in waterproofing bonding coating compositions of the present invention should function to decrease surface temperature of the coating composition when applied to a substrate that becomes exposed to sunlight, and thereby to decrease or slow down degradation to the coating composition caused by sunlight exposure, as well as to decrease or slow down degradation of any underlying waterproofing coating or membrane positioned beneath the waterproofing bonding coating compositions of the present invention. For example, a white pigment can be chosen from titanium dioxide, antimony oxide, zinc sulfide, zinc oxide, white cement, organic hollow sphere pigment, or a mixture thereof.

In a tenth example embodiment, which may be based on any of the first through ninth example embodiments above, the invention provides a method, wherein, after applying the waterproofing bonding coating composition onto the substrate in step (B), the method further comprises casting concrete against the applied waterproofing bonding coating composition (hereinafter “post-cast concrete”), and allowing the post-cast concrete to harden against the waterproofing bonding coating composition.

In an eleventh example embodiment, which may be based on any of the first through tenth example embodiments above, and wherein the method comprises casting concrete against the installed waterproofing bonding coating composition and the post-cast concrete is allowed to cure and harden against and to form a waterproofing bond with the post-cast concrete, the waterproofing bond between the coating composition and the post-cast concrete is greater than three pounds per linear inch, when tested in accordance with modified ASTM D903-98 (2017) (the testing procedure is modified by casting concrete against a waterproofing membrane to form the bond between the coating and concrete and using a peel rate of 100 mm (4 inches) per minute, whereby the waterproofing membrane is peeled away from the concrete after the concrete is allowed to harden).

In a twelfth example embodiment, the invention provides a waterproofed substrate made in accordance with the method of any of example embodiments 1 through 11 above.

In a thirteenth example embodiment, the invention provides a waterproofing bonding coating composition comprising: an aqueous synthetic polymer emulsion system comprising: at least one film-forming synthetic polymer present in the amount of 5% to 100%, preferably in the amount of 50% to 100%, more preferably in the amount of 80% to 100%, based on total weight of the aqueous synthetic polymer emulsion system, wherein the average particle size of the at least one film-forming synthetic polymer is in the range of 5 to 150 nanometers, and more preferably in the range of 5 to 100 nanometers; and, optionally, a surfactant in the amount of zero to no greater than 1%, and preferably zero to no greater than 0.5%, and most preferably zero to no greater than 0.1%, based on total weight of the aqueous synthetic polymer emulsion system.

In an example aspect of this thirteenth example embodiment, the average particle size of the at least one film forming synthetic polymer is in the range of 5 to 150 nanometers, and it is present in the amount of 5%-100% and more preferably 50%-100%, and most preferably 80%-100%, based on total weight of the aqueous synthetic polymer emulsion system. Further example aspects of the coating composition may employ at least one film forming synthetic polymer with these size and amount ranges, in addition to having another emulsion system having another size and amount range.

In another example aspect of the thirteenth example embodiment above, the aqueous synthetic polymer emulsion system comprises: at least two average particle size ranges, wherein a first average particle size range is in the range of 5 to 150 nanometers and preferably in the range of 5 to 100 nanometers, and a second average particle size range is in the range of 150 to 400 nanometers. It may be that in some cases the existence of the two average particle size ranges may be confirmed using light diffraction testing wherein the first and second average particle size ranges are detected by peaks of light intensity that are separately discernable.

In a fourteenth example embodiment, the invention provides a waterproofing membrane, comprising: (A) a carrier layer; (B) a pressure-sensitive adhesive layer; (C) optionally a protective coating layer comprising particles, elastomeric coating, or mixture thereof; and (D) a waterproofing bonding coating composition comprising: an aqueous synthetic polymer emulsion system comprising: at least one film-forming synthetic polymer present in the amount of 5% to 100%, more preferably in the amount of 50% to 100%, and most preferably in the amount of 80% to 100%, based total weight of the aqueous synthetic polymer emulsion system, wherein the average particle size of the at least one film-forming synthetic polymer is in the range of 5 to 150 nanometers and more preferably in the range of 5 to 100 nanometers; and, optionally, a surfactant in the amount of zero to no greater than 1%, and preferably zero to no greater than 0.5%, based on total weight of the aqueous synthetic polymer emulsion system. In an example aspect of this fourteenth example embodiment, the average particle size of the at least one film forming synthetic polymer is in the range of 5 to 150 nanometers, and it is present in the amount of 5%-100% and more preferably 50%-100%, and most preferably 80%-100%, based on total weight of the aqueous synthetic polymer emulsion system.

In another aspect of the fourteenth example embodiment above, the waterproofing membranes comprise at least one carrier sheet (which is sufficiently flexible that it permits rolling of the membrane for shipment, and unrolling for installation at the construction site); a pressure-sensitive adhesive (PSA) layer; optional protective coating layer (e.g., particles, elastomeric coating, or combination thereof); and, as an outermost layer for directly contacting post-cast concrete that is applied against the waterproofing membrane, the novel and inventive waterproofing bonding coating composition described in detail above.

FIG. 5 is a cross-sectional illustration of an exemplary waterproofing membrane (10) laminate of the present invention, comprising a carrier sheet (12), PSA layer (14), (optional) protective coating layer (16), and exemplary waterproofing bonding coating composition (20) of the present invention as discussed above.

Examples of carrier sheet (12) include polymer film or films (e.g., multi-layer, co-extrusion film), fabrics (e.g., extrusion coated woven, non-woven fabrics), or combinations thereof. Example polymer films, sheets, and fabrics may comprise polypropylene, polyethylene, ethylene propylene copolymers, ethylene-olefin copolymers, ethylene-vinyl acetate copolymers, polyvinyl acetate, poly (ethyl acrylate), polytetrafluoroethylene (PTFE), polyvinylidene fluoride (PVDF), polyethylene terephthalate (PET), polyvinyl chloride (PVC), polyamides, and combinations thereof. Preferably, the carrier sheet has an average thickness of 0.05 to 2.0 mm.

Examples of pressure sensitive adhesive (PSA) layer (14) include rubber-modified bituminous adhesive and synthetic polymer adhesives (non-bituminous) adhesives such as butyl rubber, polyisobutylene, styrene-isoprene-styrene (SIS), styrene ethylene-butylene-styrene (SEBS), styrene-butadiene-styrene (SBS), styrene butadiene rubber (SBR), amorphous polyolefin (APO), or a mixture of any of the foregoing adhesives. Conventional average PSA layer thicknesses can be used, and average thickness measurement can be done most conveniently after applying the PSA layer (14) onto a carrier sheet (12) film or web, using simple measuring calipers or other convenient measuring device to ensure relatively uniform coating (or more specific, adhesive coverage), before applying optional protective coating layer (16) onto the PSA (14), and before applying the waterproofing bonding coating onto the membrane (10).

Examples of (optional) protective coating layer (16) or layers include inorganic particulate or polymer synthetic (organic) particulate materials, as may for example be chosen from cement which may be partially or totally hydrated (e.g., white cement), calcium carbonate, silicate sand, sand, amorphous silica, slag, alumina trihydrate, alumina oxide, bottom ash, slate dust, granite dust, acylate resin and other polymer synthetic particulate, or mixtures thereof. The particles should preferably have an average diameter of 50-450 microns.

While the invention is described herein using a limited number of embodiments, these specific embodiments are not intended to limit the scope of the invention as otherwise described and claimed herein. Modification and variations from the described embodiments exist. More specifically, the following examples are given as a specific illustration of example embodiments of the claimed invention, and it is to be understood that the invention is not limited to the specific details set forth in the examples. All parts and percentages, as well as in the remainder of the specification, are by weight of the total coating/layer composition, unless otherwise specified.

### EXAMPLES/EXPERIMENTS

This example concerns the use of waterproofing bonding coating compositions as described above, as an outermost coating of a pre-applied type membrane used in reverse-tanking operations (i.e., having carrier layer side mounted against a substrate. Conventional pre-applied membranes typically have a carrier layer, pressure sensitive adhesive (PSA) layer, with optional protective coating (such as particulate and/or elastomeric coating), which present an outward surface against which post-cast concrete will be poured.

The exemplary waterproofing bonding coating compositions of the invention, as previously discussed above, can be additionally used as an outermost coating over optional protective coating(s), or may even replace or substitute for the protective coatings, while improving the performance of the membrane in terms of achieving a strong waterproofing bond with post-cast concrete.

Within the context of the present disclosure, the bond to concrete property (hereinafter “BTC”) refers to the strength of the waterproofing bond between the exemplary waterproofing bonding coating (as applied onto a pre-applied type membrane) and post-cast concrete. This bond strength can be measured using peel testing according to ASTM D903-98 (2017) (modified). (As mentioned elsewhere in this specification, the modification of this test involves peeling the waterproofing membrane coated with the waterproofing bonding coating away from the concrete after it is cured, at a peel rate of 100 mm (4 inches) per minute. Adhesion of a (pre-applied type) membrane to concrete is tested by casting concrete against the outermost face of 3.8 cm×15 cm (1.5 inch×6 inch) membrane samples, allowing the concrete to cure for seven days, then measuring peel adhesion with an Instron™ mechanical tester at a peel angle of 180° and a peel rate of 100 mm (4 inches) per minute. The bond strength to concrete is measured for samples not exposed to UV radiation (initial).

Within the context of the present disclosure, the term concrete “cure” or “harden” refers to the amount of time needed for concrete to reach a desired compression strength (≥˜3 kpsi). BTC peel adhesion of the membrane is only measured once concrete has reached sufficient “cure.” The waterproofing assemblies, wherein certain embodiments of the current waterproofing bonding coating are typically used, involve the membrane sample bonding to concrete while the concrete is curing. It is contemplated herein that for embodiments of the current waterproofing bonding coating where a bond to concrete is desired, the concrete mix designs are kept constant, and after about 7 days of curing at 23° C. (75° F.), the concrete reaches the desired compressive strength. For simulation of cold weather, a low-temperature BTC test can be performed where concrete accelerators are used in the concrete mix design to speed up curing at 50° F. or lower. Additional details of low temperature concrete curing, acceptable accelerators, and definitions of cold weather can be found in ACI 306R-88. The peel test can be conducted over a variety of temperatures or after a variety of exposure testing, such as water immersion or temperature cycling. The waterproofing membrane could also be subjected to a variety of environmental conditions, such as outdoor exposure at various angles, concentrated ultraviolet light exposure, high humidity, or a combination of conditions, prior to bonding to concrete or after formation of concrete-bonding layer. BTC peel adhesion is typically measured in Newton of force per millimeter (pounds per inch) of adhered waterproofing membrane, or N/mm (lbs/in). Preferably, the waterproofing system with waterproofing bonding coating, according to the present invention, has a BTC peel adhesion between about 0.53 and about 8.76 N/mm (about 3 and about 50 lbs/in), more preferably between about 0.70 and about 7.01 N/mm (about 4 and about 40 lbs/in), or even more preferably between about 0.88 and about 5.25 N/mm (about 5 and about 30 lbs/in).

Within the context of the present disclosure, the ability of waterproofing membranes to maintain waterproofing bond when subject to exposure to sunlight prior the placement of post-cast concrete against the membranes, is measured with the same procedure outlined as “BTC” peel adhesion with waterproofing membrane exposed to QUV radiation prior to casting concrete, where the UV exposure uses the QUV Accelerated Weathering Tester, testing conditions of UVA 340 nm, 0.68 w/m2/nm radiation and chamber temperature setting at 60±3° C.

Within the context of the present disclosure, the ability of waterproofing membranes to maintain waterproofing bond when subject to water exposure after the placement of post-cast concrete against the membranes, are measured with the same procedure outlined as “BTC” peel adhesion with post-cast concrete casted against waterproofing membrane and cured for seven days, the assembly is then fully immersed in water for 28 days. Water may infiltrate between any of the interfaces of the assembly including the concrete/waterproofing bonding coating interface, the waterproofing bonding coating/particulate interface, or the particulate/pressure sensitive adhesive interface.

Within the context of the present disclosure, the ability of waterproofing membrane system to unroll when it is in roll form, without the use of a removable release sheet, is evaluated in terms of blocking resistance. To test blocking resistance, the carrier sheet of the waterproofing membrane system is placed on the outermost surface of a 2.0×6.0 inch sample membrane, and subjected to about 20.7 kilopascal (3 pounds per square inch, psi) pressure at 65° C. for one week. After cooling to room temperature, each assembly is peeled apart by hand to evaluate the separation of carrier sheet and the outmost waterproofing bonding coating. An easy peel with no coating damage after pressurization and heat aging of stacked membrane is considered as blocking resistance that is sufficient for rolling/unrolling the membrane without having to use a removable release sheet.

### Testing of Exemplary Embodiment 1

In the following example, a number of exemplary waterproofing bonding coating compositions are formulated using polymer emulsions in which average particle size of the polymer are varied. The inventor discovered surprisingly that the coating formulated with small polymer particles or mix of small and big particles provide better waterproofing bonding to post-cast concrete especially after water immersion when compared to the coating with large polymer particle size only. The findings are summarized as below.

The bonding performance of waterproofing bonding coating formulated with various particle size are evaluated as a coating on a (pre-applied) waterproofing membrane which will be bonded to concrete and then peeled away to test bond strength.

As summarized in Table 1 below, twelve example waterproofing bonding coatings are identified in the left most column and also by coating numbers (Column “A”), polymer emulsion identification (Column “B), average particle size in nanometers (nm) for emulsion #1 (Column “C”), average particle size in nanometers (nm) for emulsion #2 (Column “D”, only applied to the formulation when two different polymer emulsion are used), the BTC in terms of newton per millimeter (“N/mm”) (Column “E”), and the BTC after four weeks of water immersion (Column “F”). The coatings are evaluated as waterproofing bonding coating, as an outermost layer, on a waterproofing membrane; and concrete is then cast onto the coating layer.

TABLE 1

| | A | | | | | F |
|---|---|---|---|---|---|---|
| | Waterproofing | B | C | D | E | BTC after |
| | Bonding | Polymer | Particle size | Particle Size | BTC | 4 weeks |
| Example | Coating | Emulsion | Emulsion #1 | Emulsion #2 | (N/mm) | (N/mm) |
| 1 | C1 | 1 | 350-450 | — | 1.73 | 0.00 |
| 2 | C2 | 2 | 200-300 | — | 1.50 | 0.00 |
| 3 | C3 | 3 | 200-300 | — | 3.06 | 0.00 |
| 4 | C4 | 4 | 200-300 | — | 3.14 | 0.00 |
| 5 | C5 | 5 | 100-150 | — | 3.01 | 0.76 |
| 6 | C6 | 6 | 100-150 | — | 2.96 | 2.71 |
| 7 | C7 | 7 | 5-50 | — | 3.00 | 2.70 |
| 8 | C8 | 8 | 5-50 | — | 3.00 | 0.60 |
| 9 | C9 | 1 & 7 | 350-450 | 5-50 | 2.88 | 2.49 |
| 10 | C10 | 5 & 7 | 100-150 | 5-50 | 3.80 | 3.58 |
| 11 | C11 | 6 & 7 | 100-150 | 5-50 | 2.78 | 3.54 |
| 12 | C12 | 6 & 8 | 100-150 | 5-50 | 3.46 | 3.10 |

The above exemplary waterproofing bonding coating compositions are coated onto a waterproofing membrane to obtain a four-layer laminate membrane, with the waterproofing bonding coating layer facing outermost (or upward) to receive fresh concrete. The four-layer waterproofing membrane has the following layers: 0.75 mm carrier layer, 0.3 mm pressure sensitive adhesive (PSA) layer, a particle coating (average particle size between 70-100 um) layer at coverage rate between 10-300 gram per square meter (gsm), and the sample waterproofing bonding coating layer made of the above described example coatings.

The waterproofing membrane is prepared by coating the is carrier layer with PSA to form the adhesive layer, then applying a particulate layer onto the PSA layer, and then coating this particulate layer with the exemplary waterproofing coating compositions. The exemplary waterproofing membrane, as illustrated in FIG. 5, has carrier sheet (12), PSA layer (14), (optional) protective coating layer (16) which can be particulates, and the waterproofing bonding coating composition (20). Concrete is cast against the coating composition (20) and allowed to harden.

Exemplary waterproofing bonding coating composition (20) of the invention as shown in FIG. 5 are prepared as follows. First, a pigment grind comprising water, dispersant, thickener, white pigment and filler is mixed together at high speed using a high-speed mixer. Afterwards, the polymer emulsion and additives are added and mixed in at lower speed. Other mixing sequences and techniques may be used, of course, depending on mixing techniques, available equipment, and preferences.

Thus, the waterproofing bonding coating composition is applied preferably as the last layer of the waterproofing membrane illustrated in FIG. 5. This coated membrane can then be tested and evaluated, such as for its ability to maintain a strong waterproofing bond when concrete is cast against the coating (20) side, and then allowed to harden. Once hardened, the waterproofing membrane coated with the waterproofing bonding coating composition (20) of the invention and the concrete that is cast against the coating side (20) of the membrane is subjected to water exposure.

In cases where the waterproofing bonding coating composition comprises a single particle emulsion having average particle size in the range of 350-450 nm (See Coating C1) and 250-350 nm (See Coating C2, C3, C4), respectively, the initial BTC peel adhesion of all membrane samples to post-cast concrete are above 1.5 N/mm. However, BTC peel adhesion after 4-week water immersion drops to zero (0) or has no adhesion. It is believed that the poor water resistance is caused by a large number of voids in the coating layer resulting from use of large size emulsion particles stacking during film forming. When the pre-applied waterproofing membrane is prepared with the waterproofing bonding coating comprising of a single emulsion with average particle size in the range of 100-150 nm (See coating C5 and C6) and 5-50 nm (See coating C7 and C8), respectively, the initial BTC peel adhesion values of all membrane samples to post-cast concrete are close to 3.0 N/mm. The BTC peel adhesion after 4-week water immersion is in the range of 0.60-0.76 N/mm (See coating C5 and C8) and 2.70-2.71 N/mm (See coating C6 and C7). Hence, it is believed that the smaller particle size can result in better packing density and lead to denser film formation which can in turn provide enhanced water resistance for the waterproofing membrane system.

Waterproofing bonding coating composition samples were made using two mixed emulsions with varied particle size, e.g. mix of emulsion with particle size in 350-450 nm and particle size in 5-50 nm (See coating C9) or the mix of emulsion with particle size in 100-150 nm and particle size in 5-50 nm (See coating C10, C11 and C12), and these were also tested on waterproofing membranes (See e.g., FIG. 5). Compared to the membrane configuration with coating C1 with bonding coating comprising single big particle size emulsion (350-450 nm) and no bond to concrete after 4 month water immersion, the addition of about 5% of small size emulsion based on dry polymer in waterproofing bonding coating formulation was seen to increase initial BTC from 1.7 N/mm to 3.0 N/mm and also seen to achieve above 2 N/mm waterproofing bonding after 4-week water immersion.

Waterproofing bonding coating composition samples were made using two emulsions having small polymer particle of different size, and bond strength testing on membranes and their bond to concrete were tested for BTC after water immersion and improved bond was observed. For example, the waterproofing membrane with the coating formulation C5 comprising emulsion 5 (particle size 100-150 nm) and C8 comprising emulsion 8 (particle 5-50 nm) had initial BTC of 3.0 N/mm and BTC after 4-week water immersion in the range of 0.60-0.76 N/mm. The waterproofing membrane with the coating formulation C10 comprising emulsion 5 (particle size 100-150 nm) and emulsion 7 (particle 5-50 nm) demonstrated improvement in terms of BTC after 4 weeks of water immersion at 3.58 N/mm when compared to the coating with individual emulsion (0.76 N/mm for coating with emulsion 5 and 2.7 N/mm for coating with emulsion 7). The waterproofing membrane with the coating formulation C12 comprising emulsion 6 (particle size 100-150 nm) and emulsion 8 (particle 5-50 nm) demonstrated improvement in terms of BTC after 4 weeks of water immersion at 3.1 N/mm when compared to the coating with individual emulsion (0.6 N/mm for coating with emulsion 8 and 2.71 N/mm for coating with emulsion 6). This round of evaluation indicates enhanced BTC after water immersion with coating formulation comprising emulsion having small average particle size or having the blends of different particle size as compared to emulsion having only large average particle size above 200 nm.

### Experiment of Exemplary Embodiment 2

In the following example, a number of exemplary waterproofing bonding coating compositions are formulated using polymer emulsions in which average particle sizes of the polymer are varied. The performance of waterproofing bonding coating formulated with various glass transition temperature and particle size are evaluated in the pre-applied waterproofing membrane configuration, in terms of their ability to maintain waterproofing bonding when waterproofing membrane is subject to bending, temperature exposure and UV exposure prior to the placement of post-cast concrete against the membranes, and when waterproofing membrane is subject to water exposure after the placement of post-cast concrete against the membranes. Table 2 summarized the polymer particle size and glass transition temperature (Tg, unit in ° C.) for the coating formulation and the BTC performance when evaluated as bonding coating in 4 layer configuration of pre-applied waterproofing membrane to post-cast concrete, and specific detail concerning the polymer particle emulsions in bonding coating formulation.

As shown in Table 2, the coating formulations C6 through C14 are identified (leftmost column); the emulsion or emulsion combination is identified in Column A; the glass transition temperature (Tg, unit in ° C.) is set forth in Column B; the average polymer particle size (nm) for emulsion #1 is set forth in Column C; the average polymer particle size (nm) for emulsion #2 is set forth in Column D; the percentage of emulsion with average particle size in the range of 5 nm-50 nm as a percentage based on dry weight of polymer emulsion is set forth in Column E; the percentage of emulsion with average particle size in the range of 5 nm-150 nm as a percentage based on dry weight of polymer emulsion is set forth in Column F; the existence or nonexistence of surface cracks is noted in Column G; the BTC (N/mm) is set forth in Column H; the BTC after 120 hours ultraviolet exposure (QUV per N/mm) is set forth in Column I; and BTC after 4-week water exposure (N/mm) is set forth in Column J.

Further specific detailed concerning the polymer particle emulsions in bonding coating and performance in a waterproofing membrane is discussed following Table 2 below.

TABLE 2

| Sample | A | B | C | D | E | F | G | H | I | J |
|---|---|---|---|---|---|---|---|---|---|---|
| C6 | 6 | −18 | 100-150 | — | — | 100% | no | 2.96 | 2.16 | 2.71 |
| C7 | 7 | 10-30 | 5-50 | — | 100% | 100% | yes | 3 | — | 2.7 |
| C8 | 8 | >5 | 5-50 | — | 100% | 100% | yes | 3 | — | 0.6 |
| C9 | 1&7 | (−9)/(10-30) | 350-450 | 5-50 | 5-15% | 5-15% | no | 2.88 | 2.5 | 2.49 |
| C10 | 5&7 | (−10)/(10-30) | 100-150 | 5-50 | 5-15% | 90-100% | no | 3.8 | 3.15 | 3.58 |
| C11 | 6&7 | (−18)/(10-30) | 100-150 | 5-50 | 5-15% | 90-100% | no | 2.78 | 3.24 | 3.54 |
| C12 | 6&8 | (−18)/(>5) | 100-150 | 5-50 | 5-15% | 90-100% | no | 3.46 | 3.43 | 3.1 |
| C13 | 6&8 | (−18)/(>5) | 100-150 | 5-50 | 5-15% | 90-100% | no | 3.2 | 3.2 | 4.0 |
| C14 | 6&9 | (−18)/{(−11)-(−2)} | 100-150 | 5-50 | 20-50% | 90-100% | no | 3.7 | 2.3 | 3.3 |

The waterproofing coating composition formulation examples were layered onto a waterproofing membrane to provide a four-layer membrane. An example waterproofing membrane comprises a carrier layer (0.75 mm), PSA layer (0.3 mm), particle coating layer wherein average particle size is 50-200 μm and the particles have coverage rate of 10-300 gram per square meter (gsm), and the sample waterproofing bonding coating composition layer (as formulated above).

To prepare the waterproofing membrane, the carrier layer is coated with polymer based pressure sensitive adhesive, then laminate with particulate layer over the adhesive, and then apply the waterproofing bonding coating onto over the particulate layer to desired coat weight. Following such process, a four layer membrane (10) comprising carrier sheet (12), waterproofing pressure sensitive adhesive (14), particulate protective coating layer (16), and waterproofing bonding coating composition layer (20) as the outermost protective topcoat is obtained, having the general laminate structure illustrated in FIG. 5.

Waterproofing bonding coating compositions are prepared by first preparing a pigment grind (paste) that comprises, dispersant, thickener, white pigment and filler which are mixed together at high speed using high-speed mixer; and then the polymer particle emulsion and other additives can be added and mixed at lower mixing speed.

The sample membranes (e.g., having structure similar to that illustrated in FIG. 5) are evaluated with respect to the waterproofing bonding coating layers (20) and their respective polymer particle features. The example of the coating using small average particle-size emulsion (less than 150 nm), as well as the combination of emulsions with small average particle size or the combination of emulsions with small average particle size and large average particle size (150 nm), demonstrated good bonding to concrete after water immersion and after QUV aging. The sample membranes with emulsion 7 and 8 (See coating C7, C8) with glass transition temperature (Tg) of polymer emulsion above 5° C. demonstrated surface cracking, however. The other examples having emulsions with Tg below 0° C. or combination of two polymer emulsion, and one polymer having Tg below 0° C., seemed to have no surface cracks and could therefore presumably maintain waterproofing bond.

### Testing of Exemplary Embodiment 3

In the following examples, the coverage rate of waterproofing bonding coating is evaluated in a pre-applied waterproofing membrane. Hence, a three-layer membrane was used having a carrier sheet, a pressure-sensitive adhesive (PSA) layer, but no protective coating layer over the PSA, such that a waterproofing bonding coating layer is applied directly onto the PSA layer. The waterproofing bonding coating formulation C11 was used: the present inventors believe that this provided some of the protection that would otherwise have been provided by a particle- or elastomer-based protective coating layer (as shown at 16 in FIG. 5).

TABLE 4
(Testing of membrane using Coating C11 at different coating weights)

| | | | | BTC after 4- | |
|---|---|---|---|---|---|
| | | | BTC after 120 | week water | |
| Waterproofing | Coverage Rate | | hrs QUV | immersion | |
| Bonding Coat | (gsm) | BTC (N/mm) | (N/mm) | (N/mm) | Blocking |
| C11 | 34 | 3.57 | 2.22 | 2.33 | Block |
| C11 | 74 | 3.51 | 2.73 | 2.34 | No |
| C11 | 130 | 1.25 | 2.11 | 2.11 | No |

At three different level of coating coverage, waterproofing bonding coating C11 comprises two polymer particle emulsions, one emulsion with average particle size between 100-150 nm, one emulsion with polymer containing siloxane reactive functional group and average particle size less than 50 nm. The C11 coating formulation demonstrated good bonding to concrete, good retention of bond to concrete after 28-day water immersion, and good bond to concrete after QUV exposure.

All the above examples showed that the waterproofing bonding coating formulation, when used as a protective top coating, has excellent water resistance and UV resistance for pre-applied waterproofing membrane applications where concrete is post-cast against the installed membrane. The fine particle size emulsion and hydrophobic property are believed to form denser coating layers and provide good water resistance properties; while the white pigment and siloxane group in the polymer latex formulation of coating C11 can enhance anti-weather properties.

Blocking resistance (or ability to prevent adhesive side from sticking to the carrier side when the membrane is rolled up onto itself for shipment to a building site) can depend upon the coating weight of the outermost coating layer. Low coverage weight at 34 gsm could not cover all the pressure sensitive adhesive to provide sufficient blocking property. For membrane constructions in which waterproofing bonding coating formulations are applied directly onto the PSA layer (without protecting coating and/or particles to prevent the pressure sensitive adhesive adhere to carrier sheet when wounded in roll form without release sheet), the appropriate coverage rate of bonding coating should be used to obtain a satisfactory blocking resistance property, and the minimum thickness of the outer coating layer can depend upon many design factors (e.g., tenacity of the PSA layer, the choice of components within the waterproofing bonding coating composition). Coating at coverage rate of 74 gsm and above (in this exemplary embodiment, 140 gsm) can provide good blocking resistance performance. Sufficient coverage is also related to the dispersion performance of the spray equipment, such that use of same top coating weight, better dispersion property is believed to lead to smaller droplets for better coverage.

When particulates are used as a protective coating layer between the PSA layer and outermost coating layer, a membrane with waterproofing bonding coating at coverage rate of 42 gsm and above (in this exemplary embodiment, 140 gsm) could provide sufficient blocking property. But, again, this depends upon other selected design factors. For example, the effective contact surface between protective top coating/waterproofing bonding coating and HDPE carrier layer is taken into consideration; but this consideration may well be influenced by the extent to which the particulate layer, particle size and distribution, the coverage rate, the depth of particle embedment in PSA and the nature of particles, provides uneven surface topography and effectively makes surface contact smaller.

The foregoing examples and embodiments were present for illustrative purposes only and not intended to limit the scope of the invention.

All features disclosed in the specification, including the claims, abstract, and drawings, and all the steps in any method or process disclosed, may be combined in any combination, except combinations where some of such features and/or steps are mutually exclusive. Each feature disclosed in the specification, including the claims, abstract, and drawings, can be replaced by alternative features serving the same, equivalent, or similar purpose, unless expressly stated otherwise.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A method for establishing a waterproofing bond with post-cast concrete, comprising:
(A) providing a substrate chosen from formwork, a waterproofing membrane established by application of a previous coating composition or a rollable/unrollable sheet-form membrane having a carrier layer, a building surface, a civil engineering surface, or any combination of the foregoing substrates; and
(B) applying onto the substrate, to establish a waterproofing bond for concrete that is subsequently cast against the substrate, a waterproofing bonding coating composition which is an aqueous synthetic polymer emulsion system comprising: (i) at least one film-forming synthetic polymer present in the amount of 5% to 100%, preferably in the amount of 50% to 100%, more preferably in the amount of 80% to 100%, based total dry weight of the aqueous synthetic polymer emulsion system, wherein the average particle size of the at least one film-forming synthetic polymer is in the range of 5 to 150 nanometers; and, optionally, (ii) a surfactant in the amount of zero to no greater than 1%, and preferably zero to no greater than 0.5%, all percentages of polymer above being based on total dry weight of the aqueous synthetic polymer emulsion system.

2. The method of claim 1 wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 150 nanometers, is present in the amount of 50% to 100%.

3. The method of claim 1 wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 150 nanometers, is present in the amount of 80% to 100%.

4. The method of claim 1 wherein, in applying the waterproofing bonding coating composition onto the substrate in step (B), the waterproofing bonding coating composition comprises at least one film-forming synthetic polymer, having average particle size of the at least one film-forming synthetic polymer in the range of 5 to 100 nanometers, is present in the amount of 5% to 100%.

5. The method of claim 1 wherein, in applying onto the substrate in step (B), the waterproofing bonding coating composition is applied at a coverage rate of 10-2500 grams per square meter (gsm), more preferably in the range of 20-200 gsm, and most preferably in the range of 30-100 gsm, based on total dry weight of the aqueous synthetic polymer emulsion system.

6. The method of claim 1 wherein, in applying the waterproofing bonding coating composition onto the substrate in step (B), the waterproofing bonding coating composition has glass transition temperature no less than −20° C. and no greater than 100° C., more preferably no greater than 85° C., and most preferably no greater than 65° C.

7. The method of claim 1, in applying the waterproofing bonding coating composition onto the substrate in step (B), the waterproofing bonding coating composition has glass transition temperature below 0° C.

8. The method of claim 1 wherein, in applying the waterproofing bonding coating composition onto the substrate in step (B), the waterproofing bonding coating composition further comprises a polymer emulsion chosen from fluoroacrylate or fluorinated polymers, copolymer with carboxyl and siloxane functionality that can react or form strong interactions with cement, or a mixture thereof.

9. The method of claim 1 wherein, in applying the waterproofing bonding coating composition onto the substrate in step (B), the waterproofing bonding coating composition comprises at least one white pigment, and preferably wherein the white pigment is chosen from titanium dioxide, antimony oxide, zinc sulfide, zinc oxide, white cement, organic hollow sphere pigment, or a mixture thereof.

10. The method of claim 1 wherein, after applying the waterproofing bonding coating composition onto the substrate in step (B), the method further comprises casting concrete against the applied waterproofing bonding coating composition (hereinafter “post-cast concrete”), and allowing the post-cast concrete to harden against the waterproofing bonding coating composition.

11. The method of claim 10 wherein the post-cast concrete is allowed to cure and harden against, and to form a waterproofing bond with, the post-cast concrete, and further wherein the waterproofing bond between the coating composition and the post-cast concrete is greater than 0.53 Newton per millimeter or three pounds per linear inch, when tested in accordance with modified ASTM D903-98 (2017), wherein the testing procedure is modified by casting concrete against a waterproofing membrane to form the bond between the coating and concrete and using a peel rate of 100 mm (4 inches) per minute, whereby the waterproofing membrane is peeled away from the concrete after the concrete is allowed to harden.

12. A waterproofed substrate made according to the method of claim 1.

13. A coating composition comprising: an aqueous synthetic polymer emulsion system comprising: at least one film-forming synthetic polymer present in the amount of 5% to 100%, more preferably in the amount of 50% to 100%, and most preferably in the amount of 80% to 100%, based total weight of the aqueous synthetic polymer emulsion system, wherein the average particle size of the at least one film-forming synthetic polymer is in the range of 5 to 150 nanometers; and, optionally, a surfactant in the amount of zero to no greater than 1%, and preferably zero to no greater than 0.5%, and most preferably zero to no greater than 0.1% based on total weight of the aqueous synthetic polymer emulsion system.

14. A waterproofing membrane, comprising: (A) a carrier layer; (B) a pressure-sensitive adhesive layer; (C) optionally a protective coating layer comprising particles, elastomeric coating, or mixture thereof; and (D) a waterproofing bonding coating composition comprising: an aqueous synthetic polymer emulsion system comprising: at least one film-forming synthetic polymer present in the amount of 5% to 100%, more preferably in the amount of 50% to 100%, and most preferably in the amount of 80% to 100%, based total weight of the aqueous synthetic polymer emulsion system, wherein the average particle size of the at least one film-forming synthetic polymer is in the range of 5 to 150 nanometers; and, optionally, a surfactant in the amount of zero to no greater than 1%, and preferably zero to no greater than 0.5%, and most preferably zero to no greater than 0.1% based on total weight of the aqueous synthetic polymer emulsion system.

15. The coating composition of claim 13 further wherein the at least one film-forming synthetic polymer has an average particle size in the range of 5 to 150 nanometers, and is present in the amount of 50% to 100%.

16. The coating composition of claim 13 further wherein the at least one film-forming synthetic polymer has an average particle size in the range of 5 to 150 nanometers, and is present in the amount of 80% to 100%.

17. The coating composition of claim 13 further wherein the at least one film-forming synthetic polymer has an average particle size in the range of 5 to 100 nanometers, and is present in the amount of 5% to 100%.

18. The waterproofing membrane of claim 14 further wherein the at least one film-forming synthetic polymer has an average particle size in the range of 5 to 150 nanometers, and is present in the amount of 50% to 100%.

19. The waterproofing membrane of claim 14 further wherein the at least one film-forming synthetic polymer has an average particle size in the range of 5 to 150 nanometers, and is present in the amount of 80% to 100%.

20. The waterproofing membrane of claim 14 further wherein the at least one film-forming synthetic polymer has an average particle size in the range of 5 to 100 nanometers, and is present in the amount of 5% to 100%.
